(19) United States
(12) Patent Application Publication
(10) Pub. No.: US 2011/0256501 A1
(43) Pub. Date: Oct. 20, 2011

(54) Delivery syringe for flowable dental compound

(76) Inventor: Christopher James Lampert, Portland, OR (US)

(21) Appl. No.: 13/083,551

(22) Filed: Apr. 9, 2011

Related U.S. Application Data
(60) Provisional application No. 61/342,546, filed on Apr. 16, 2010.

(51) Int. Cl. A61C 5/04

(52) U.S. Cl. 433/90

(57) ABSTRACT

The present invention provides a delivery syringe and a set of delivery syringes for flowable composite materials that overcome the difficulties associated with currently available composite delivery methods. Specifically, the present invention provides a flowable composite delivery syringe with a vibratory mechanism. The vibratory mechanism allows the composite material to contain a higher filler load and still have desirable flow characteristics. The higher filler load produces a stronger composite material with less shrinkage during the curing process. Additionally, the vibratory mechanism contained in the delivery syringe prevents air entrapment voids during the delivery of the composite material into the tooth cavity preparation.

This application claims the benefit of and priority to U.S. Provisional Application No. 61/342,546, entitled “DELIVERY SYRINGE FOR FLOWABLE DENTAL COMPOUND”, filed Apr. 16, 2010, the entire disclosure of which is hereby incorporated by reference as if set forth in their entirety for all purposes.

### FIELD OF THE INVENTION

The present invention relates generally to viscous flowable dental compounds delivered by a syringe apparatus. More specifically, the present invention relates to flowable resin based composite restorative materials delivered to a tooth cavity preparation by a syringe.

### BACKGROUND OF THE INVENTION

Resin based light-cured composite compounds are a come dental restorative material for replacing decayed areas of a natural tooth. The composite materials are tooth colored and have a reduced viscosity producing a flowable consistency. Following delivery of the flowable composite material into the tooth cavity preparation, the material is light-cured by an ultraviolet light source producing polymerization of the resin-based composite.

Over the past ten years, composite materials have been developed which have a lower viscosity, which enables them to flow into the tooth cavity preparation and easily adapt to the shape of the tooth cavity. Dentists desire the flowable consistency of these composite materials because they are easy to deliver into the tooth cavity preparation by using a common plunger type syringe as shown in FIG. 1. FIG. 1 shows a prior art flowable composite delivery syringe 1, having a plunger handle 3 located on the proximal end of the plunger 5. The plunger 5 extends into the syringe barrel 7, the composite material is held within the barrel 7 and is extruded out the tip 9 when the plunger 5 is pushed into the barrel 7.

A common problem for all flowable composite materials is that air is incorporated into the flowable composite material as it moves through the syringe barrel 7, out the syringe tip 9, and into the tooth cavity preparation. The air is then trapped within the composite material during the light-activated curing process, which produces air entrapment voids within the material. Air entrapment voids are an undesirable outcome, particularly if they are located between the tooth surface and the composite restorative material because this will become a site for further tooth decay. Furthermore, air entrapment voids located within the core of the composite material compromise the strength of the restoration and can lead to fracture of the filling material during chewing.

Another inherent problem with existing flowable composite materials relates to the filler content necessary to produce a flowable consistency. The filler load of a composite material is directly related to its strength and inversely related to the amount that the composite material shrinks during the curing process. To produce a flowable consistency for use in a syringe delivery, the filler component of the composite must be reduced; the reduction of filler load reduces the strength of the cured composite material. Reducing the filler component also increase the shrinkage that occurs during the curing process. Shrinkage is another undesirable characteristic of flowable composite materials because shrinkage of the material during the setting process compromises the adhesion of the material to the tooth structure.

Flowable dental composite materials and delivery syringes are shown and described in U.S. Pat. Nos. 6,767,955 B2 (Jia), 6,569,122 B2 (Fischer et al), 5,364,267 (Fischer et al), 6,306,927 B1 (Blackwell), 5,647,851 (Pokras), 6,602,229 (Coss), and 5,591,027 (Muhlbauer), the entire disclosures of which patents are hereby incorporated by reference as if set forth in their entirety for all purposes.

### SUMMARY OF THE INVENTION

The present invention provides a delivery syringe for flowable composite materials that overcome the difficulties associated with currently available composite delivery methods. Specifically, the present invention provides a flowable composite delivery syringe with a vibratory mechanism. The vibratory mechanism allows the composite material to contain a higher filler load and still have desirable flow characteristics. The higher filler load produces a stronger composite material with less shrinkage during the curing process. Additionally, the vibratory mechanism contained in the delivery syringe prevents air entrapment voids during the delivery of the composite material into the tooth cavity preparation.

The composite delivery syringe of the present invention has a vibration generator, a battery source, and an on/off actuator. The vibration generator provides vibration to the syringe tip during the extrusion of flowable composite material into the tooth cavity preparation. The vibrating syringe tip transfers the vibration forces to the flowable composite material as it flows into the cavity preparation and removes air bubbles from the composite material. The vibration forces from the syringe tip cause the existing air bubbles in the flowable composite material to coalesce and move to the surface of the composite material. The removal of the air bubbles prevents air entrapment voids in the cured composite material, producing a stronger tooth restoration with a better seal.

As another embodiment of the current invention, the vibration source also improves the flowability of the composite material. Improving flowability allows for easier delivery of the composite material into the tooth cavity preparation. Because flowability of the composite material is improved, the filler component of the composite material can be increased to produce a stronger finished restoration with less shrinkage.

As another embodiment, the current invention is a set of composite delivery syringes, the syringes in the set have a connection site for the self contained vibration apparatus (vibration generator, battery source, and on/off actuator) which can be easily attached and detached from the delivery syringes to allow the vibration apparatus to be used on all syringes contained in the composite syringe set. This is important during a restorative dental procedure because multiple syringes of different colors of composite are required to match the color of the composite restoration to the color of the patient's teeth. Easily moving the vibration apparatus between different colored composite syringes will shorten the procedure time for the dentist and the patient. FIG. 2 shows a set of flowable composite syringes 11 used in restorative dentistry. Each syringe in the set 11 is a different color or shade of composite material, for example shade A1, A2, A3, and A4 are shown in FIG. 2.

The vibration apparatus can be attached to the syringe by any desired mechanism, such as twist threads, spring clips, press-fit friction, adhesive materials, and magnetic connection assemblies. The desired connection mechanism for the current invention utilizes a magnetic attachment site to connect the vibration apparatus to the composite syringe. The vibration apparatus can also be attached at any site along the syringe plunger, syringe barrel, or syringe tip. The desired location for the current invention is located on the proximal end of the plunger handle.

These and other embodiments are described in more detail in the following description of the drawings and detailed description of the invention. The foregoing is not intended to be an exhaustive list of embodiments and features of the present invention. Persons skilled in the art are capable of appreciating other embodiments and features from the following detailed description in conjunction with the drawings.

### BRIEF DESCRIPTION OF THE DRAWINGS

FIG. 1 is an illustration of a prior art flowable dental composite material syringe.

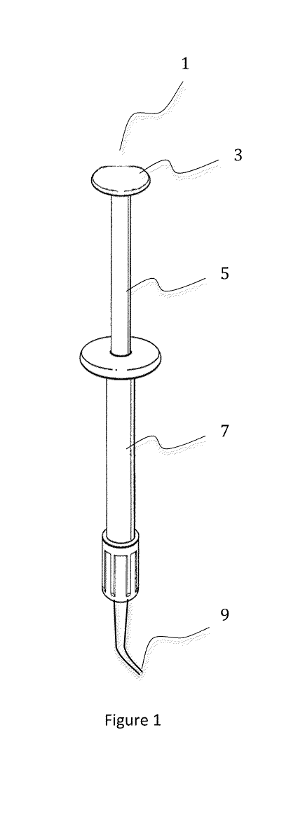

FIG. 2 is an illustration of a set of prior art flowable dental composite syringes containing different shades of composite restorative material.

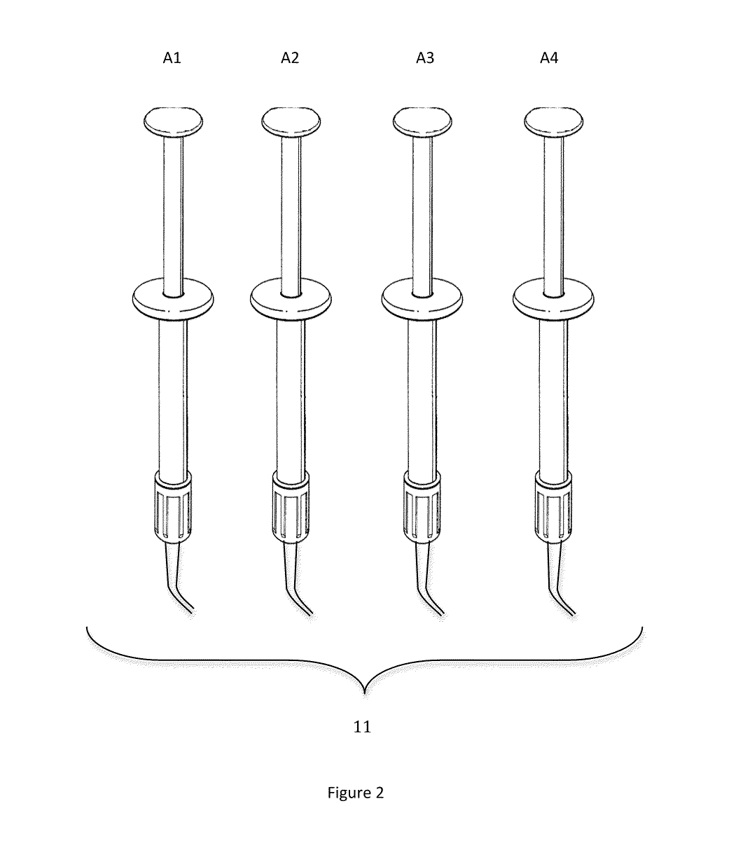

FIG. 3 is an illustration of the inventive flowable dental composite material syringe with a vibratory mechanism.

FIG. 4 is an illustration of the inventive flowable dental composite material syringe showing the attachment/detachment of the vibration apparatus to the composite syringe.

FIG. 5 is an illustration of a set of flowable composite material syringes showing the vibration apparatus having the ability to be moved from syringe to syringe within the set.

### DETAILED DESCRIPTION OF THE INVENTION

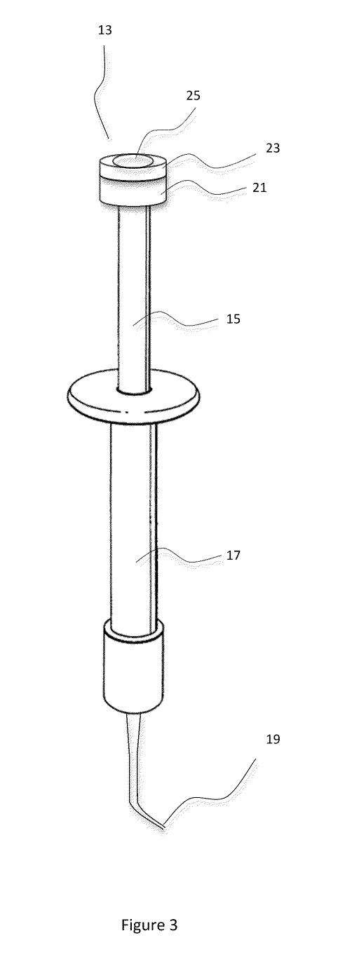

The inventive flowable dental composite delivery syringe 13 is shown in FIG. 3 having a plunger 15, which extends into a composite filled barrel 17 and a delivery tip 19. The vibration generator 21, battery source 23, and on/off actuator 25 are located on the proximal end of the syringe plunger 17. When finger pressure is exerted on the on/off actuator 25, the vibration generator 21 is activated and the plunger 15 extrudes flowable composite material from the syringe barrel 17 out the syringe tip 19. Vibrations are transferred from the vibration generator 21 through the plunger 15 and barrel 17 to the syringe tip 19.

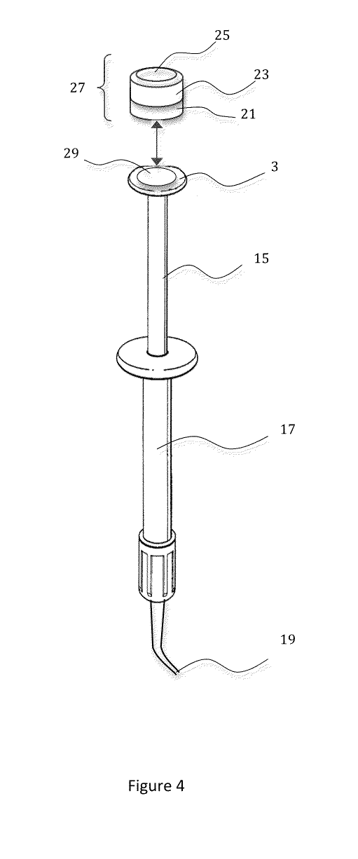

FIG. 4 illustrates an alternative embodiment of the current invention showing the vibration apparatus 27, consisting of a vibration generator 21, battery source 23, and an on/off actuator 25. The self-contained vibration apparatus 27 is attachable and detachable from the delivery syringe (←→) plunger handle 3. The vibration apparatus 27 has a metallic surface that makes a magnetic connection to a magnet 29 located on the plunger handle 3 allowing the vibration apparatus 27 to be easily removed from the syringe. Other modifications and variations are possible for attaching the vibration apparatus to the syringe, such as twist threads, spring clips, adhesive materials, and press-fit friction assemblies. These and other variations do not depart from the spirit and scope of the teachings of a removable vibration apparatus contained herein.

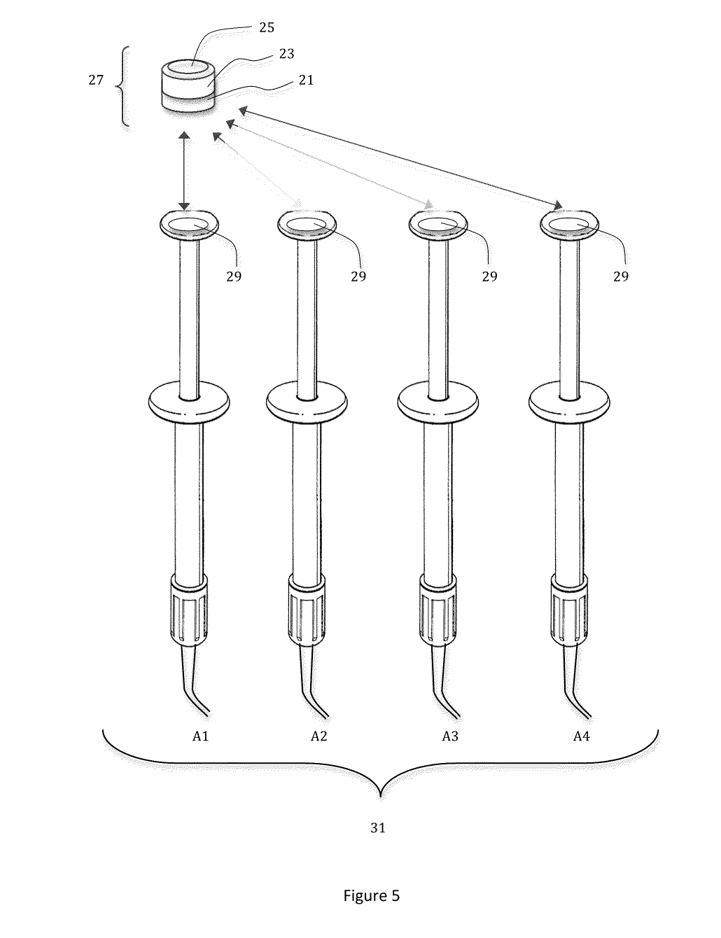

FIG. 5 shows the current invention and a set of flowable composite syringes 31. The set of flowable composite syringes 31 consists of multiple syringes containing different colored composite materials A1, A2, A3, and A4. Each syringe in the set 31 has a magnetic connection assembly 29 located on the proximal end of the plunger handle. The vibration apparatus 27 can be easily moved from syringe to syringe depending on what color of flowable composite material is needed.

Although FIGS. 4 and 5 show the vibration apparatus connected to the proximal end of the plunger handle, the vibration apparatus can be connected at any location on the syringe plunger, barrel, or tip, which allows the vibration forces to be transferred to the extruded flowable composite material.

Persons skilled in the art will recognize that many modifications and variations are possible in the details, materials, and arrangements of the parts and actions which have been described and illustrated in order to explain the nature of this invention; and that such modifications and variations do not depart from the spirit and scope of the teachings and claims contained therein.

What is claimed:

1. A set of flowable dental composite delivery syringes, each syringe having a connection site for a self contained vibration apparatus that can be easily moved from syringe to syringe within the set of composite delivery syringes, the vibration apparatus containing a vibration source, battery source, and on/off actuator, wherein the vibration source increases the flowability of the extruded flowable composite material and reduces air entrapment in the dispensed composite material.

2. The set of flowable dental composite delivery syringes in claim 1, wherein the vibration apparatus attaches to the composite syringe by a magnetic connection assembly.

3. The set of flowable dental composite syringes in claim 2, wherein the vibration apparatus attaches to the proximal end of the syringe plunger.

4. The set of flowable dental composite syringes in claim 1, wherein the vibration apparatus is activated when finger pressure is applied to the syringe plunger and the syringe plunger is pushed into the syringe barrel.

5. The set of flowable dental composite syringes in claim 1, wherein the vibration apparatus is deactivated when finger pressure is removed from the syringe plunger.

6. The set of flowable dental composite delivery syringes in claim 1, wherein the vibration apparatus attaches to the composite syringe by a twist thread connection assembly.

7. The set of flowable dental composite delivery syringes in claim 1, wherein the vibration apparatus attaches to the composite syringe by a spring clip connection assembly.

8. The set of flowable dental composite delivery syringes in claim 1, wherein the vibration apparatus attaches to the composite syringe by an adhesive connection assembly.

9. The set of flowable dental composite delivery syringes in claim 1, wherein the vibration apparatus attaches to the composite syringe by a press-fit friction connection assembly.

10. The set of flowable dental composite delivery syringes in claim 1, wherein the vibration apparatus attaches to the composite syringe by a retentive snap-on connection assembly.

11. A flowable dental composite delivery syringe, having a vibration apparatus that transfers vibration to the syringe tip and the dispensed flowable composite material as it enters a tooth cavity, wherein the vibration source increases the flowability of the extruded flowable composite material and reduces air entrapment in the dispensed composite material.

12. The flowable dental composite delivery syringe in claim 11, wherein the vibration apparatus is easily attached and detached from the delivery syringe by a magnetic connection assembly.

13. The flowable dental composite delivery syringe in claim 11, wherein the vibration apparatus is easily attached and detached from the delivery syringe by a twist thread connection assembly.

14. The flowable dental composite delivery syringe in claim 11, wherein the vibration apparatus is easily attached and detached from the delivery syringe by a spring clip connection assembly.

15. The flowable dental composite delivery syringe in claim 11, wherein the vibration apparatus is easily attached and detached from the delivery syringe by an adhesive connection assembly.

16. The flowable dental composite delivery syringe in claim 11, wherein the vibration apparatus is easily attached and detached from the delivery syringe by a press-fit friction connection assembly.

17. The flowable dental composite delivery syringe in claim 11, wherein the vibration apparatus is easily attached and detached from the delivery syringe by a retentive snap-on connection assembly.
